(19) United States
(12) Patent Application Publication
(10) Pub. No.: US 2003/0182070 A1
(43) Pub. Date: Sep. 25, 2003

(54) New defect detection technique for media certification

(76) Inventors: Jun Zhu, Palo Alto, CA (US); Douglas Peale, Fremont, CA (US)

Correspondence Address: IRELL & MANELLA LLP, 840 NEWPORT CENTER DRIVE, SUITE 400, NEWPORT BEACH, CA, 92660, US

(21) Appl. No.: 10/103,482

(22) Filed: Mar. 20, 2002

(51) Int. Cl. G01B 5/28; G01B 5/30; G06F 19/00

(52) U.S. Cl. 702/35

(57) ABSTRACT

A disk certifier that increases the signal to noise ratio of signals used to detect defects on a disk. The certifier includes a plurality of filters that each have a centering frequency located at a characteristic wavelength of the defects. The filters may be digital in nature and utilize a plurality of adjacent peak sample values taken from a sinusoidal signal read from the disk. The outputs of the filters are compared with a threshold value by a threshold detector. The outputs of the threshold detectors can be provided to an analyzer to determine defects in the disk.

### BACKGROUND OF THE INVENTION

1. Field of the Invention

The present invention relates to a disk certifier for detecting defects on a disk.

2. Background Information

Hard disk drives are used to store large amounts of electronic information on magnetic disks that are rotated by a spindle motor of the drive. Each side of a disk is coupled to a corresponding head. The head can both magnetize, and sense the magnetic field of an adjacent disk surface, to write and read information, respectively.

The disks are typically manufactured separately before being assembled into a hard drive. The disks may have one or more defects caused by, or during, the manufacturing process. It is desirable to detect the defects before assembling the disks into the hard drive.

There are two primary inspection techniques for detecting disk defects. One, is to physically inspect the surface of the disk. This can be done with an optical based system. The second type of inspection technique involves writing a test signal onto the disk surface, and then reading the test signal back from the disk. Defects in the disk tend to attenuate or otherwise distort the test signal. The test signal read from the disk is analyzed to detect defects. The apparatus that is used to perform this type of disk inspection is commonly referred to as a disk certifier.

The test signal typically has a sinusoidal waveform that has a plurality of periodic peaks. The electrical circuits of the certifier will sample the test signal to obtain peak values. The peak sample values are then compared with a threshold value. Peaks below the threshold value are identified as defect areas of the disks.

Electrical noise may be introduced to the system which reduces the signal to noise ratio of the test signal. A lower signal to noise ratio may cause errors in the detection of defects on the disks. It is desirable to provide a technique and corresponding structure that increases the signal to noise ratio when detecting defects on a disk.

### BRIEF SUMMARY OF THE INVENTION

A disk certifier that includes a defect filter which has a centering frequency located at a defect characteristic wavelength. The output of the defect filter if compared with a threshold value to detect a defect(s) on a disk.

### BRIEF DESCRIPTION OF THE DRAWINGS

FIG. 1 is schematic of a disk certifier;

FIG. 2 is a graph showing a test signal;

FIG. 3 is a schematic showing digital filters and threshold detectors of the certifier.

### DETAILED DESCRIPTION

Disclosed is a disk certifier that increases the signal to noise ratio of signals used to detect defects on a disk. The certifier includes a plurality of filters that each have a centering frequency located at a characteristic wavelength of the defects. The filters may be digital in nature and utilize a plurality of adjacent peak values taken from a sinusoidal test signal read from the disk. The outputs of the filters are compared with threshold values by corresponding threshold detectors. The outputs of the threshold detectors can be provided to an analyzer to determine defects in the disk.

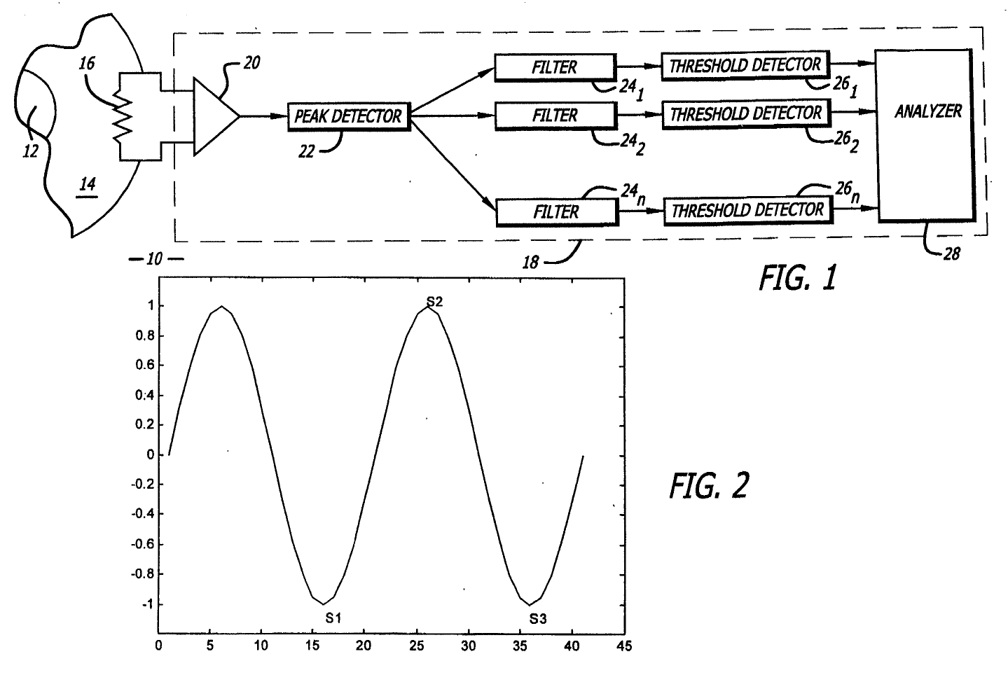

Referring to the drawings more particularly by reference numbers, FIG. 1 shows an embodiment of a disk certifier 10. The certifier 10 includes a spindle motor 12 that can rotate a disk 14. The disk 14 is to be inspected by the certifier 10 to detect and identify disk defects.

The certifier further has a head 16 that can both magnetize and sense the magnetic field of the disk 14. Although one head 16 is shown, it is to be understood that there is typically a head 16 for each surface of the disk 14. Additionally, although one disk 14 is shown and described, it is to be understood that the certifier 10 can analyze a plurality of disks 14 assembled onto a disk stack.

The head 16 is coupled to a defect detection circuit 18. The defect detection circuit 18 can detect disk defects from a test signal that is read from the disk 14 through the head 16. Although not shown, the certifier 10 also contains a write circuit that can write the test signal onto the disk 14 through the head 16. The test signal typically has a sinusoidal, or other periodic, waveform.

The defect detection circuit 18 may include an amplifier 20 that amplifies the read signal from the head 16. The detection circuit 18 may further include a peak detector 22 that detects and outputs the peak value of the test signal.

The peak detector 22 is coupled to one or more defect filters 24₁-24ₙ. One or more of the filters 24 may be bandpass filters. The output of each filter 24 is provided to a corresponding threshold detector 26₁-26ₙ. The threshold detectors 26 compare the output of the corresponding filter 24 with a threshold value. By way of example, a defect can be identified when the output of one or more filters is below corresponding threshold values. The outputs of the threshold detectors 26 can be provided to a defect analyzer 28. The defect analyzer 28 can be a computer that analyzes the data provided by the threshold detectors 24 and correlates detected defects with the defect locations on the disk 14.

The disk defects can be characterized as having a defect length and a corresponding characteristic wavelength as shown in Table I.

TABLE I

| Characteristic Wavelength | Defect Length |
|---|---|
| Fₘₐₓ | 1-bit error |
| Fₘₐₓ/4 to Fₘₐₓ/2 | 2 to 4 bit error |
| Fₘₐₓ/8 to Fₘₐₓ/4 | 4 to 8 bit error |
| Fₘₐₓ/16 to Fₘₐₓ/8 | 8 to 16 bit error |
| Fₘₐₓ/32 to Fₘₐₓ/16 | 16 to 32 bit error |
| Fₘₐₓ/64 to Fₘₐₓ/32 | 32 to 64 bit error |
| < = Fₘₐₓ/64 | > = 64 bit errors |

Fₘₐₓ is the write data frequency, which is twice the signal frequency. Each filter 24 has a centering frequency located at a defect characteristic wavelength. For example, filter 24₁ may have a centering frequency at Fₘₐₓ, filter 24₂ may have a centering frequency between Fₘₐₓ/2 to Fₘₐₓ/4. By including bandpass filters with centering frequencies centered about the defect wavelengths the certifier can detect defects while rejecting spurious noise outside of the pass-band. This reduces the errors in detecting defects in the disk. The lower frequency characteristic wavelengths tend to have higher signal to noise ratios, as these include a larger range of sample points.

FIG. 2 shows an exemplary test signal read from the disk 14. The test signal is a sinusoidal waveform which has peaks S₁, S₂ and S₃. To determine a defect at sample S₂, the samples S₁ and S₃ can also be analyzed in conjunction with S₂. For example, the operation abs(S₁−S₂)<V _{threshold} can be performed on peak samples S₁ and S₂. This operation is equivalent to a high-pass filter in the form of 1-D, where D denotes the delay of one sampling interval combined with a demodulator operating at the bit-rate. The operation abs (S₂−(S₁+S₃)/2)<V_{threshold} is equivalent to a band-pass filter in the form of D−(1+D²)/2 combined with a demodulator operating at the bit-rate.

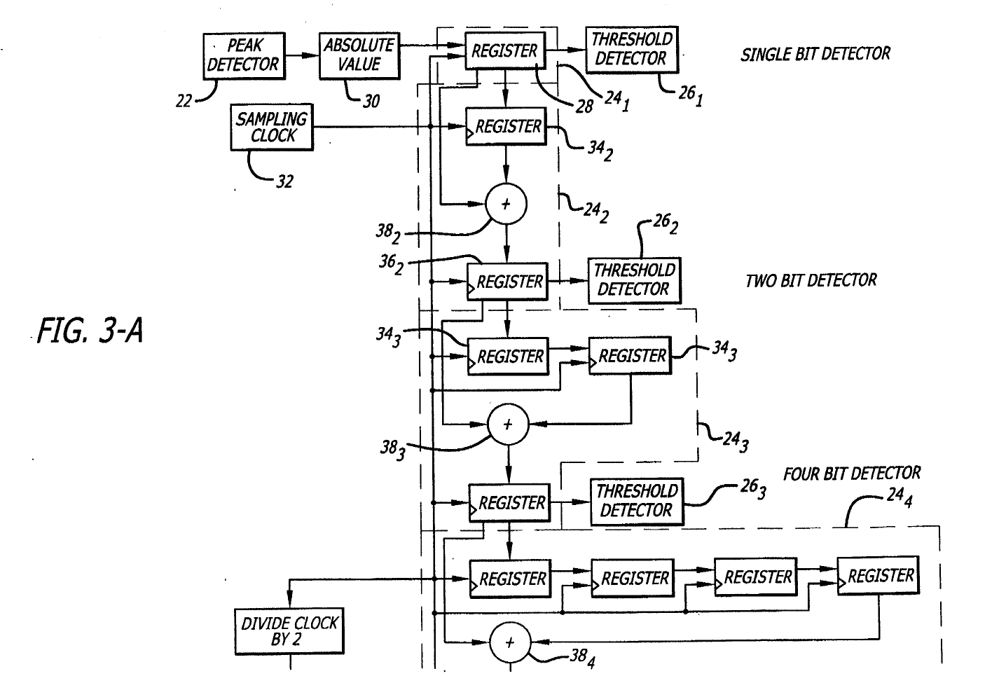

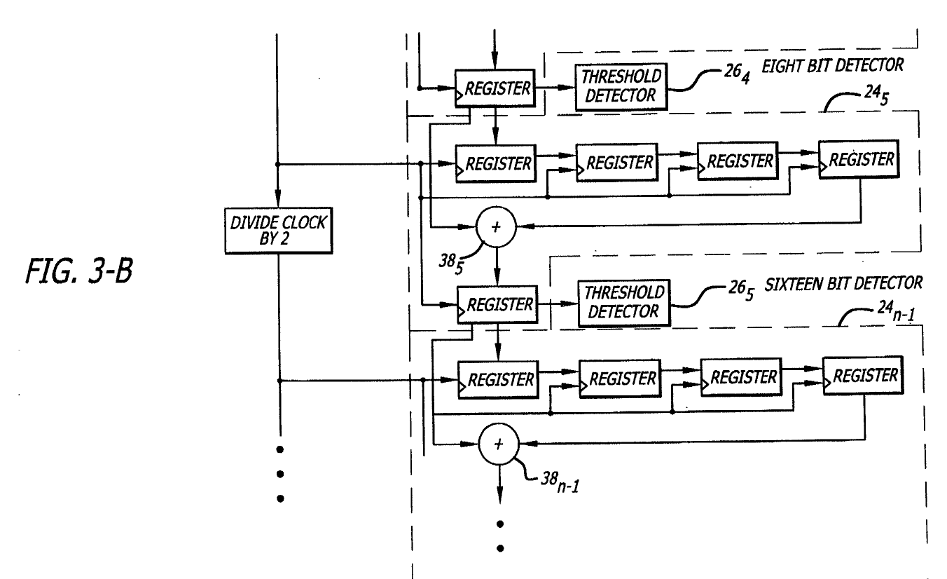

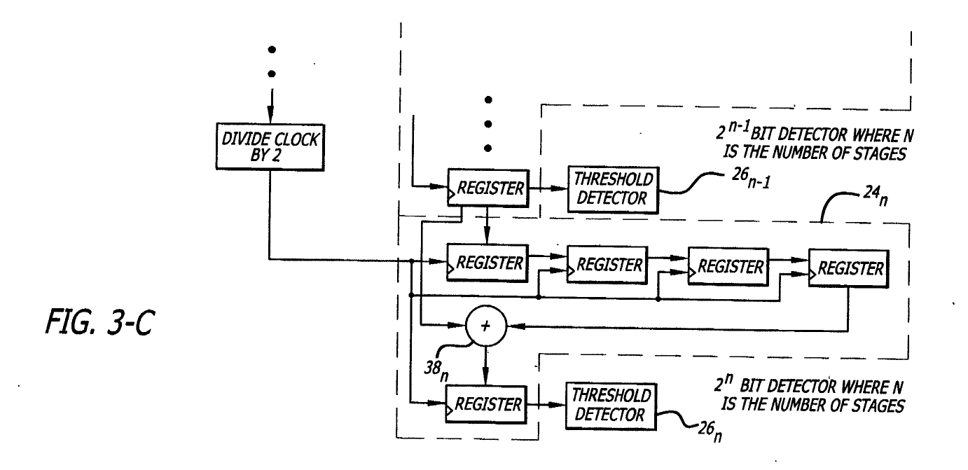

FIG. 3 shows an embodiment where the filters 24₁-24ₙ are digital filters. Each filter is 24 is connected to a corresponding threshold detector 26. Each filter/threshold detector pair comprise an n bit defect detector. For example, the filter 24₁ and threshold detector 26₁ define a single bit detector. Filter 24₂ and detector 26₂ define a two bit detector, filter 24₃ and detector 26₃ define a four bit detector.

The filter 24₁ of the single bit detector includes a register 28 that is connected to an absolute value operator 30. The absolute value operator 30 is connected to the output of the peak detector 22. The peak detector 22 may include an analog to digital converter to convert the peak amplitude value into a binary code. The operator 30 converts the output of the peak detector 22 to an absolute value.

The register 28 is connected to a sample clock 32. The sample clock 32 generates a series of clock pulses that clock the peak values into the register 28 from the peak detector 22, and from the register 28 to the threshold detector 26₁. Although not shown, the clock 32 will typically be integrated into a phase lock loop that acquires a phase lock with the read test signal so that the clock pulses occur at the peaks of the test signal.

The filters 24₂-24ₙ each include a shift register 34₂-34ₙ, an output register 36₂-36ₙ and a summing junction 38₂-38ₙ. The filters 24₂-24ₙ utilize a number of peak values. For example, the four bit detector adds, instead of one data point, four peak sample values. Comparing a number of data points with a threshold value increases the signal to noise ratio of the processed test signal. The contents of the registers 32 and 34 are shifted in accordance with the pulses provided by the clock 32. Filters 24₄-24ₙ may include divide by two frequency dividers 40 to reduce the sample rate, and therefore the number of shift registers 34 to detect longer errors.

In operation, a disk 14 is loaded onto the spindle motor 12. This operation is typically performed with some type of automated arm. The spindle motor 12 rotates the disks 14 and a test signal(s) is written onto the disk surface through the head 16. The test signal is then read back from the disk 14, filtered by the filters 24 and compared by the threshold detectors 26. The output of the threshold detectors 26 is provided to the analyzer 28 to store the occurrence of defects and defect locations on the disk 14. The process of reading, filtering and comparing the read signal is continued to cover the relevant portions of the disks 14. After the test signal is read, the disk 14 is replaced with another disk unit and the entire process is repeated.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

Although a discrete disk certifier is shown and described, it is to be understood that the disk certification technique described herein may be integrated into another system such as a servowriter.

What is claimed is:

1. A disk certifier that can detect defects on a disk, wherein the defects have a first characteristic wavelength, comprising:
a spindle motor;
a head;
a first defect filter coupled to said head and having a centering frequency at the first characterstic wavelength; and,
a first threshold detector coupled to said first defect filter.

2. The certifier of claim 1, wherein said first defect filter is a bandpass filter.

3. The certifier of claim 2, wherein said first defect filter includes a plurality of shift registers coupled to an adder, and an absolute value operator.

4. The certifier of claim 1, further comprising a second defect filter that is coupled to said head and a second threshold detector coupled to said second defect filter, said second defect filter having a centering frequency that corresponds to a second defect characteristic wavelength.

5. The certifier of claim 1, further comprising an amplifier and a peak detector coupled to said head and said first defect filter.

6. A disk certifier that can detect defects on a disk, wherein the defects have a first characteristic wavelength, comprising:
a spindle motor adapted to rotate the disk;
a head adapted to read a signal from the disk, the signal having a plurality of peaks;
a peak detector coupled to said head, said peak detector provides a plurality of peak values from the signal;
a first defect filter coupled to said peak detector which utilizes a plurality N of peak values; and,
a first threshold detector that compares the N number of peak values with a threshold value.

7. The certifier of claim 6, wherein said first defect filter is a bandpass filter.

8. The certifier of claim 7, wherein said first defect filter includes a plurality of shift registers coupled to an adder, and an absolute value operator.

9. The certifier of claim 6, further comprising a second defect filter that utilizes N+2 peak values, and a second threshold detector that compares the N+2 peak values with a threshold value.

10. The certifier of claim 9, further comprising a clock that provides a clock signal to said first defect filter, and a divide by two circuit that is coupled to said clock and said second defect filter.

11. A disk certifier that can detect defects on a disk, comprising:
rotating means for rotating the disk;
transducer means for reading a signal from the disk, the signal representing disk defects which have a first characteristic wavelength;
first defect filter means for filtering the signal at a centering frequency of the first characteristic wavelength; and,
first threshold detector means for comparing the filtered signal with a threshold value to detect a defect.

12. The certifier of claim 11, wherein said first defect filter means includes a bandpass filter.

13. The certifier of claim 12, wherein said first defect filter means includes a plurality of shift registers coupled to an adder, and an absolute value operator.

14. The certifier of claim 11, further comprising second defect filter means for filtering the signal at a centering frequency of a second defect characteristic wavelength, and second threshold detector means for comparing the filtered signal of said second defect filter means with a threshold value.

15. The certifier of claim 11, further comprising amplifier means for amplifying the signal, and peak detector means for providing peak values of the signal.

16. A disk certifier that can detect defects on a disk, wherein the defects have a first characteristic wavelength, comprising:
rotating means for rotating the disk; transducer means for reading a signal from the disk, the signal having a plurality of peaks;
peak detector means for obtaining a plurality of peak values from the signal;
first defect filter means for utilizing a plurality N of peak values; and,
first threshold detector means for comparing the N number of peak values with a threshold value to detect a defect.

17. The certifier of claim 16, wherein said first defect filter means includes a bandpass filter.

18. The certifier of claim 17, wherein said first defect filter means includes a plurality of shift registers coupled to an adder, and an absolute value operator.

19. The certifier of claim 16, further comprising second defect filter means for utilizing N+2 peak values, and second threshold detector means for comparing the N+2 peak values with a threshold value.

20. The certifier of claim 19, further comprising a clock that provides a clock signal to said first defect filter means, and a divide by two circuit that is coupled to said clock and said second defect filter means.

21. A method for detecting defects on a disk, comprising:
writing a test signal onto a disk;
reading the test signal from the disk, the test signal containing disk defect information that has a first defect characteristic wavelength;
filtering the test signal through a first defect bandpass that has a centering frequency located at the first defect characteristic wavelength; and,
comparing the filtered read signal with a threshold value to detect a defect.

22. The method of claim 21, wherein the test signal is filtered by utilizing a plurality of peak values of the test signal.

23. A method for detecting defects on a disk, comprising:
writing a test signal onto a disk;
reading the test signal from the disk, the signal containing disk defect information that has a first defect characteristic wavelength;
obtaining a plurality of N peak values from the test signal; and,
comparing the N peak values with a threshold value to detect a defect.

24. The method of claim 23, further comprising comparing N+2 peak values with a threshold value.
